(19) United States
(12) Patent Application Publication
(10) Pub. No.: US 2014/0004389 A1
(43) Pub. Date: Jan. 2, 2014

(54) EXOTHERMIC COMPONENT, ELECTRODE CONSTRUCTION, ELECTRICAL ENERGY CELL AND CELL ASSEMBLY, AS WELL AS A MANUFACTURING AND ACTUATION METHOD

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/979,942

(22) PCT Filed: Jan. 3, 2012
(86) PCT No.: PCT/EP2012/000015

§ 371 Date: Sep. 16, 2013

(30) Foreign Application Priority Data
Jan. 17, 2011 (DE) 10 2011 008 706.0

(51) Int. Cl. H01M 10/42

(52) U.S. Cl. CPC H01M 10/4257
USPC 429/7; 429/211; 429/90; 429/61; 29/623.1

(57) ABSTRACT

An exothermic component has a reactive multilayer arranged in grid-shape fashion on a carrier. The exothermic component can be incorporated in an electrode construction of a galvanic cell comprising electrode layers, a separator layer and current collecting layers. In addition, a matrix-like sensor arrangement can be provided in the electrode construction. Defect locations in the electrode construction can be identified on the basis of output signals of the sensor arrangement. By igniting selected regions of the reactive multilayer grid, which react exothermically, it is possible to destroy the defect locations in a targeted manner.

The entire content of priority application DE 10 2011 008 706.0 is hereby incorporated by reference into the present application as an integral part hereof.

The present invention relates to an exothermic component, an electrode construction, electrical energy cell and a cell assembly, a method for manufacturing an exothermic component and a method for actuating an electrical energy cell or cell assembly respectively.

In the context of the present invention, electrical energy cells refer to devices which are also capable of releasing electrical energy. Electrical energy cells refer for example, but not restrictively, to primary and secondary battery cells (galvanic cells), fuel cells, capacitor cells, super-capacitors such as for instance supercaps and the like.

A trend can be seen in battery technology toward primary and (particularly) secondary batteries (accumulators) having increasing power density. Material combinations comprising lithium are also used. Defects in the construction of electrode structures can lead to malfunctioning of the cell or to other unwanted occurrences such as for instance a loss of power or a rise in temperature or the like. Such defects can be present in the electrode structure from the outset, for instance due to crystal imperfections, or can develop over time, for instance from aging or mechanical damage, and/or initial crystal imperfections may only become apparent or worsen over time. A cell having an electrode construction with defects can become useless or impair other cells over time due for example, but not restrictively, to excessive temperatures developing or un-reliable functioning such that it can only be subjected to a limited charge and needs to be electrically removed from the cell assemblage or even replaced. There is a need to extend the operating life of cells having an electrode construction comprising defects or to at least partially maintain its output respectively, by selectively making allowances for said defects.

A heat flow regulating cover for an electrical storage cell is known from DE 11 2004 000 385 T5 which is able to generate heat at a hot spot during a short circuit condition. The cover comprises a first layer of thermally conductive material which is formed so as to conform to an outer surface of the electrical energy storage cell and distribute heat from the hot spot over a surface area larger than the hot spot. The cover also comprises a second layer of thermally insulating material which is formed so as to conform to an outer surface of the first layer and retard the heat flow to an outer surface of the second layer. Hence, the maximum surface temperature of the cell can be reduced and the surface temperature of the second layer kept below a predefined limit.

A fuel cell having a membrane electrode assembly arranged adjacent to a porous gas diffusion layer is known from WO 03/038924 A2. The membrane electrode assembly is activated by reactants being supplied thereto. The porous gas diffusion layer operates to selectively limit the amount of reactants reaching specific areas of the membrane electrode assembly in order to reduce hot spots. In the similar WO 03/038936 A1 from the same applicant, a porous layer of an electrically conductive material having a positive temperature coefficient in the Z-axial direction (such a layer is hereinafter abbreviated as “PTC conductive layer”) is provided in place of the porous gas diffusion layer, whereby the porous PTC conductive layer operates to selectively limit the amount of electrons received (collected) from specific areas of the membrane electrode assembly in order to reduce hot spots.

In accordance with DE 2007 046 939 A1, a liquid coolant flows through a fuel cell assembly, whereby the pressure of the coolant is monitored as to its reaching or falling below a predetermined threshold value after flowing through the fuel cell assembly, wherein the threshold value is greater than the coolant's boiling balance pressure. Since there is a risk of vapor film forming, and thus local overheating in the fuel cell upon reaching or falling below the boiling balance pressure, damage to the fuel cell assembly due to such local overheating can be prevented by monitoring the coolant pressure.

One objective of the present invention is improving the prior art structure particularly (but not restrictively) with respect to the above-cited criteria.

Using nanometer reactive multilayers as energy stores for joining heat-sensitive components is known from p. 76 of the “Fraunhofer IWS Jahresbericht 2008” {annual report}. Such nanometer reactive multilayers (also abbreviated as “RMS” in the following) consist of several hundred up to several thousand individual layers, each 10-100 nm thick, of at least two different materials which release energy when chemically combined (exothermic reaction). Thus, a defined quantity of chemical energy is stored in the RMS which can be used as a local heat source. After ignition by an external energy source, such as for example an electrical spark or a laser pulse, an atomic interdiffusion of the multilayer materials is initiated along with the release of energy. A progressive reaction front is formed from which a large amount of thermal energy is released in a spatially limited area within a very short amount of time. Fast-reacting multilayer films are used in so-called exothermic soldering foils as localized sources of heat for producing soldered joints; doing so can minimize the heat and stress input into adjacent components. The RMS are produced with total thicknesses of up to 100 μm, for example in a physical vapor deposition process such as magnetron or ion beam sputter deposition (German: “Ablagerung”), and can be coated directly onto the respective components or fabricated as separate films. With material combinations such as for instance Ni/Al or Ti/Al, locally achievable temperatures of up to 2000° C. as well as propagation speeds of 2-20 m/s are for example cited.

The objective is accomplished by the features of the independent claims. Advantageous further developments of the invention constitute the subject matter of the subclaims.

The invention evolved from the consideration that it would be desirable to be able to selectively “eliminate” defects in an electrode construction of an electric energy cell but keep the “healthy” sections adjacent defects functional at least for the most part. To this end, the invention makes use of reactive multilayers (RMS).

According to one aspect of the invention, an exothermic component having a reactive multilayer is proposed, wherein the reactive multilayer is arranged discontinuously on a substrate, particularly in a grid pattern.

In the terms of the invention, a reactive multilayer is to be understood as an arrangement of at least two, preferably several hundred or several thousand individual layers of at least two different materials which react together exothermically upon an ignition pulse, wherein the thickness of an individual layer preferably amounts to less than 1 μm, particularly a few 10 to 100 nm, and the total thickness of the multilayer preferably amounts up to 100 μm. In the terms of the invention, a discontinuous arrangement is to be understood as an arrangement of areas delimited from each another, wherein delimitation refers to an ignited reaction in one area not being able to encroach into a neighboring area. A grid-like arrangement in the sense of the invention refers to an at least substantially regular arrangement in one or two directions, particularly in the form of strips, spots, points (pixels) or the like, whereby the spacing to the grid can be for example, but not restrictively, a few centimeters or decimeters, a few millimeters or in the submillimeter range depending on the specific application.

The grid can be realized for example, but not restrictively, by the rastered forming of the reactive multilayer and the subsequent creation of channels by etching or by mechanical machining or the like in a continuously formed reactive multilayer, wherein the channels (boundaries) can be filled with non-reactive materials. In the terms of the invention, a substrate is to be understood as any structure which is also capable of supporting the multilayer, for instance a foil provided specifically for the purpose or another functional layer or component. The discontinuity, particularly the rastering to the reactive multilayer, limits the exothermic reaction to one area or a few areas of the reactive multilayer upon said area(s) being subjected to an ignition pulse, which allows intense heat to be generated on a limited localized basis.

The exothermic component preferably comprises a functional layer for actuating the reactive multilayer. It is particularly preferential for the functional layer to comprise a matrix-like arrangement of circuit elements, particularly thin-film transistors, whereby the matrix-like arrangement of circuit elements is correlated to the rastered arrangement of the reactive multilayer. This matrix-like arrangement of thin-film transistors allows for example selectively subjecting specific areas of the reactive multilayer to an ignition pulse (e.g. a voltage pulse) and thus selectively igniting the selected areas.

A further aspect of the invention proposes an electrode construction having a successive arrangement of a first electrode layer, a separator layer and a second electrode layer, wherein the first electrode layer is connected to a first current collecting layer and wherein the second electrode layer is connected to a second current collecting layer, wherein the separator layer is disposed between the first electrode layer and the second electrode layer, and wherein the electrode construction comprises an exothermic component as described above. Such an electrode construction comprising the exothermic component with the rastered reactive multilayer arrangement enables selected areas of the electrode construction which contain defects to be selectively targeted for destruction or isolation by the igniting of the respective reactive multilayer areas without unduly affecting adjacent healthy areas of the electrode construction. The healthy areas of the electrode construction can therefore continue to be used for the receiving, converting, storing and releasing of energy.

The electrode construction preferably comprises a second functional layer having a matrix-like arrangement of sensor elements, wherein the sensor elements are configured to sense the electrode construction's operating parameters. In the terms of the invention, the temperature can for example, but not exclusively, be considered as an operating parameter. The second functional layer can be integrated into the functional layer of the exothermic component. The matrix-like arrangement of sensor elements can, albeit not mandatorily, correlate to the matrix-like arrangement of circuit elements or the rastered arrangement of the reactive multilayer. The matrix-like arrangement of sensor elements enables detecting the electrode construction's operating parameters directly and as a two-dimensional value field (parameter field, e.g. temperature field). Conclusions can be drawn from the parameter field as to the position and criticality of defects, if need be also chronologically. From that, a decision can in turn be made as to whether and, if so, which areas of the reactive multilayer should be ignited so as to selectively target the respective areas of the electrode construction for destruction.

The invention is also directed toward an electrical energy cell having an electrode construction as described above as well as a cell assembly comprising a plurality of such cells in series and/or parallel connection. The electrical energy cell can comprise evaluation logic for evaluating the sensor outputs and/or actuation logic for actuating the circuit elements. The cell assembly can comprise control logic connected to the evaluation logic and/or the actuation logic of all the cells of the cell assembly. The control logic can be a part of a battery manage-ment system and the evaluation logic and/or actuation logic of the electrical energy cells can be at least partially implemented in the control logic of the cell assembly or battery management system respectively. In the terms of the invention, a logic is to be understood as a device which is also able to perform logical operations. A logic can be particularly, but not restrictively, embodied in an integrated or non-integrated circuit, an electronic control unit, an electronic controller, a microcomputer or the like.

In the terms of the invention, an electrical energy cell is to be understood as an apparatus which is also designed and configured to release electrical energy. This can in particular, but not exclusively, be a primary or secondary electrochemical storage cell (battery or accumulator cell), a fuel cell or a capacitor cell. An active part of the cell, particularly an electrochemical (galvanic) cell, within which electrochemical charging, discharging and as need be converting processes also occur, comprises an electrode construction having layers which are respectively embodied by films or disposed (deposited, etc.) on films. In the terms of the invention, a film is to be understood as a thin semi-finished product produced from metal and/or plastic. The film can thereby serve as a substrate for a material having the desired electrical and/or chemical properties or can itself be manufactured from the material having the cited properties. The layers comprise electrochemically active materials (electrode layers), electrically conductive materials (current collecting or collector layers) and separating materials (separator layer). In the terms of the invention, a collector or current collecting layer refers to a layer which is also designed and configured to collect and conduct electrical charges. A collector layer can for example, but not restrictively, be a conductor film, particularly a metal film, or a plastic film coated with a conductive material, particularly metal or carbon or the like. In the terms of the invention, electrochemically active material is to be understood as materials which also take part in an electrochemical reaction in the active part.

In the terms of the invention, an electrical energy cell also for example comprises an enclosure and terminal contact areas. In the terms of the invention, an enclosure also refers to a gas, vapor and liquid-tight casing which accommodates at least the active part (electrode assembly or galvanic element) and encloses it on all sides. The enclosure can comprise a multilayer film as needed, a multi-part frame as needed or a multi-part housing as needed. In the terms of the invention, terminal contact areas are to be understood as areas accessible from outside the enclosure which enable an exchange of electrical energy with the active part. Terminal contact areas can for example, but not restrictively, be so-called conductors connected to the active part inside the enclosure and which lead out of the enclosure through a wall, a seam or a gap in the enclosure or can themselves be formed by electrically conductive parts and/or sections of the enclosure.

A further aspect of the invention proposes a method for manufacturing an exothermic component, particularly as described above. The method comprises the steps of: furnishing a substrate and applying a reactive multilayer to the substrate in discontinuous, particularly raster-defined areas. Alternatively, the method comprises the steps of: furnishing a substrate; applying a reactive multilayer to the substrate and forming channels in the reactive multilayer in order to leave discontinuous, particularly raster-defined areas in the reactive multilayer.

A further aspect of the invention proposes a method for actuating an electrical energy cell or a cell assembly, particularly as described above. The method comprises the steps of: assessing whether a defect is present in an electrode construction of the electrical energy cell; determining the location of the defect, expressed in two-dimensional coordinates; and actuating at least one circuit element in order to route an ignition pulse to one area or a plurality of areas of the reactive multilayer corresponding to the spatial coordinates of the defect. It is particularly preferential for the assessment step to comprise the step of processing the output signals from the sensor elements.

The above and further features, objectives and advantages of the present invention will become more clearly evident from the following description which references the accompanying figures.

The figures show:

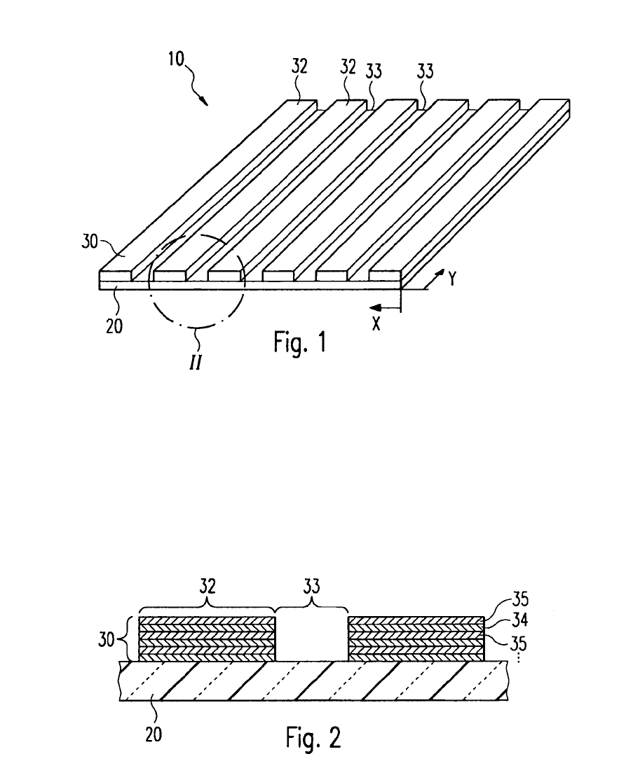

FIG. 1 a spatial view of an RMS arrangement according to one embodiment of the invention;

FIG. 2 a cross-sectional view of the RMS arrangement from FIG. 1 in the area of detail II;

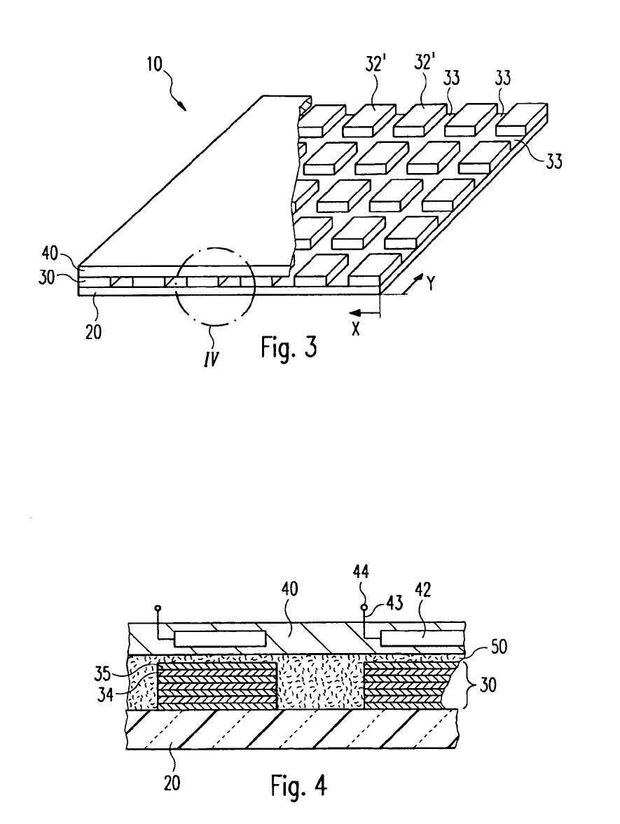

FIG. 3 a spatial view of an RMS arrangement according to a further embodiment of the invention;

FIG. 4 a cross-sectional view of the RMS arrangement from FIG. 3 in a depiction corresponding to FIG. 2;

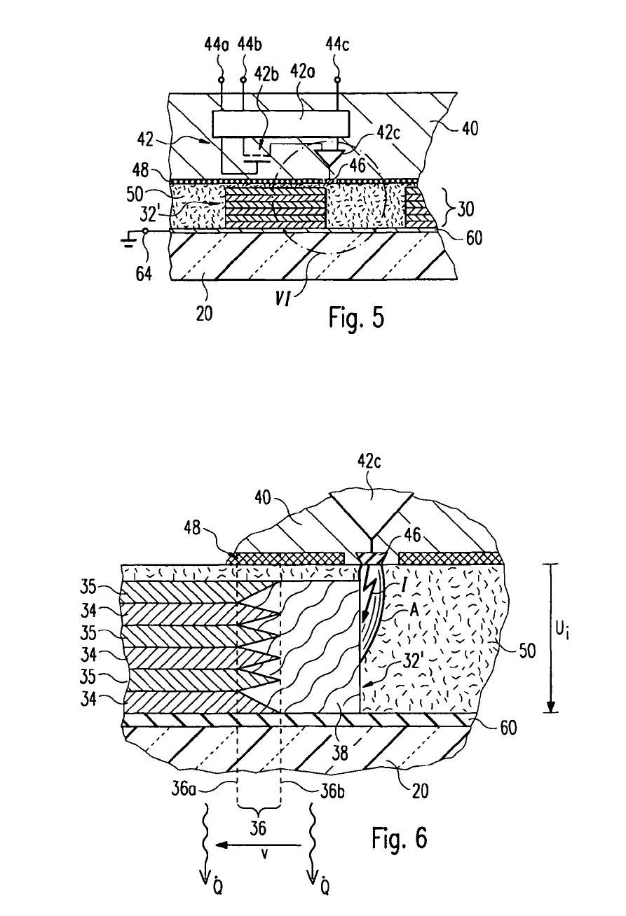

FIG. 5 a cross-sectional view of the RMS arrangement according to a further embodiment of the invention in a depiction corresponding to FIG. 2;

FIG. 6 an enlarged view of detail VI from FIG. 5 in a state of actuation;

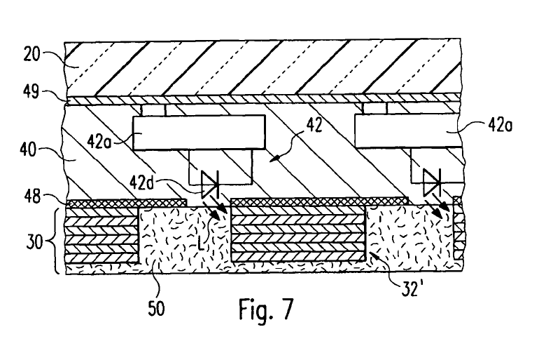

FIG. 7 a cross-sectional view of an RMS arrangement according to a further embodiment of the invention in a depiction corresponding to FIG. 2;

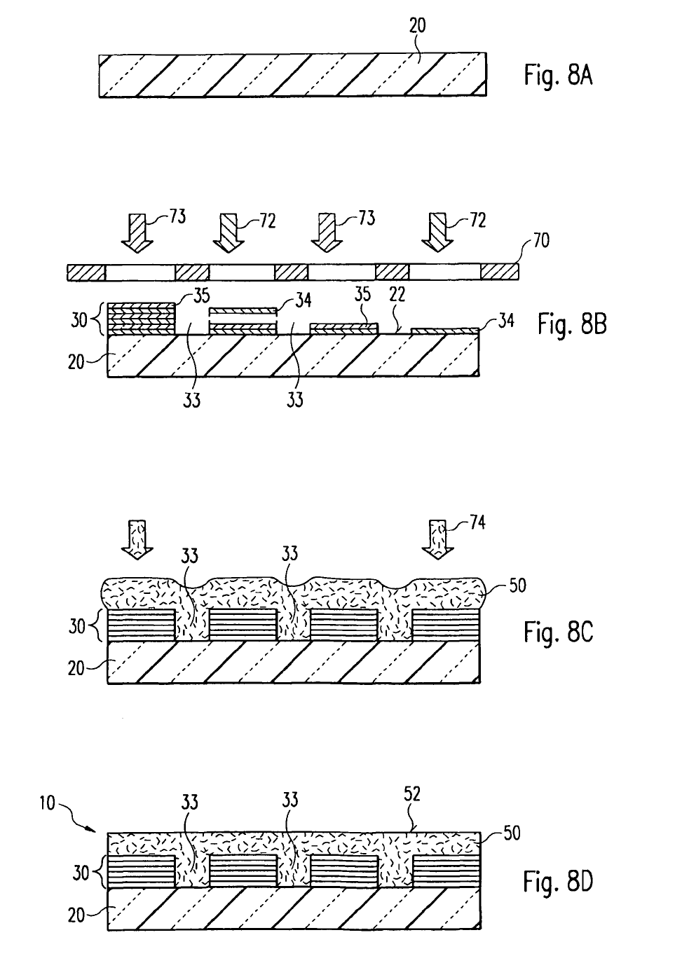

FIGS. 8A to 8D are cross-sectional views of a layered structure in different stages of a manufacturing method for manufacturing an RMS arrangement in accordance with a further embodiment of the invention;

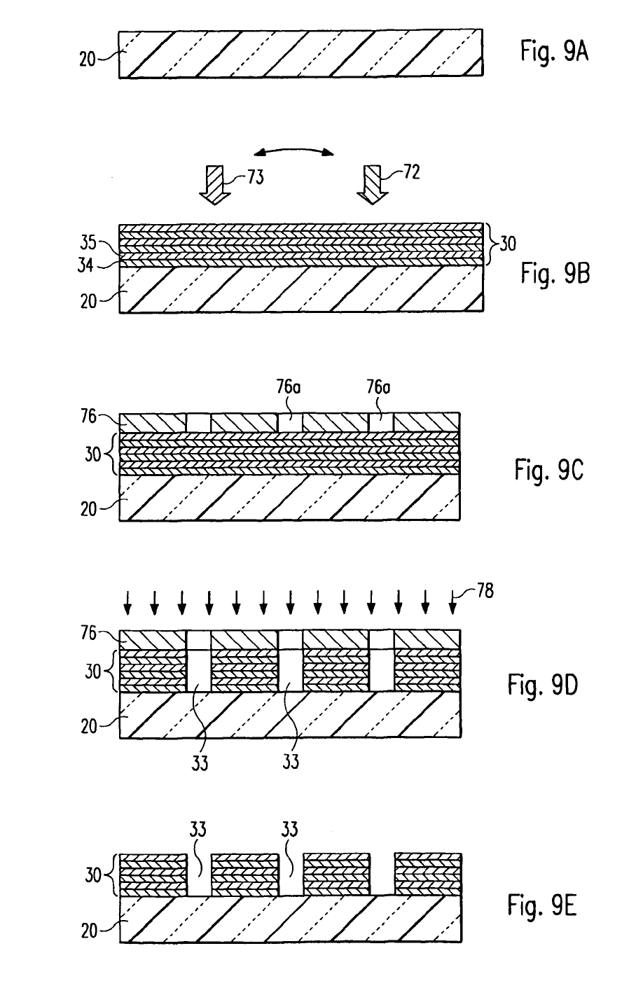

FIGS. 9A to 9E are cross-sectional views of different stages of a manufacturing method in accordance with a further embodiment of the invention;

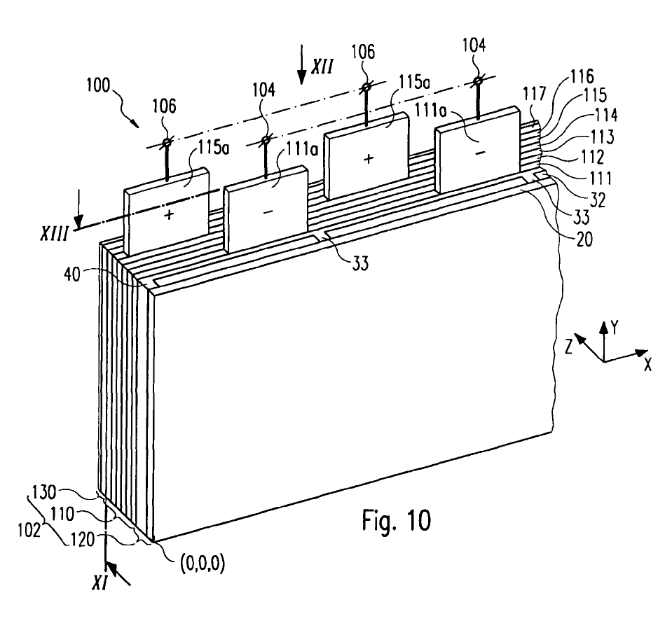

FIG. 10 a spatial representation of an electrode assembly according to a further embodiment of the invention;

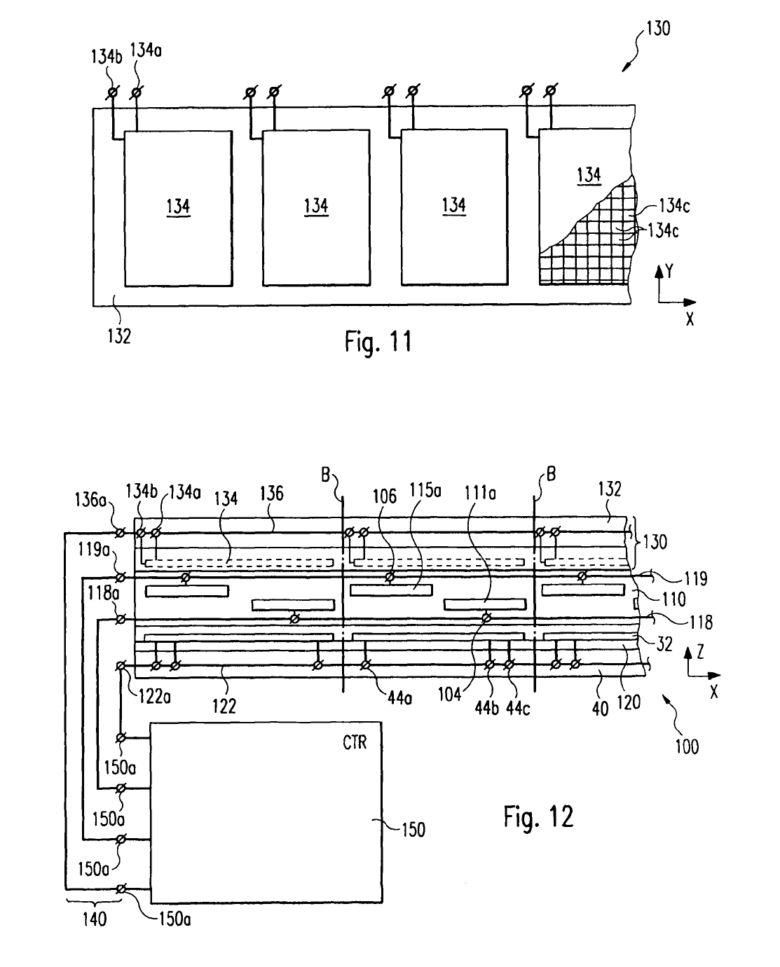

FIG. 11 a sectional view of a surface of a sensor arrangement in the cell of FIG. 10 along a plane indicated by the dotted “XI” line from FIG. 10 in the viewing direction of the associated arrow;

FIG. 12 a plan view of a connection side of the electrode assembly from FIG. 10 in the viewing direction of the “XII” arrow in FIG. 10;

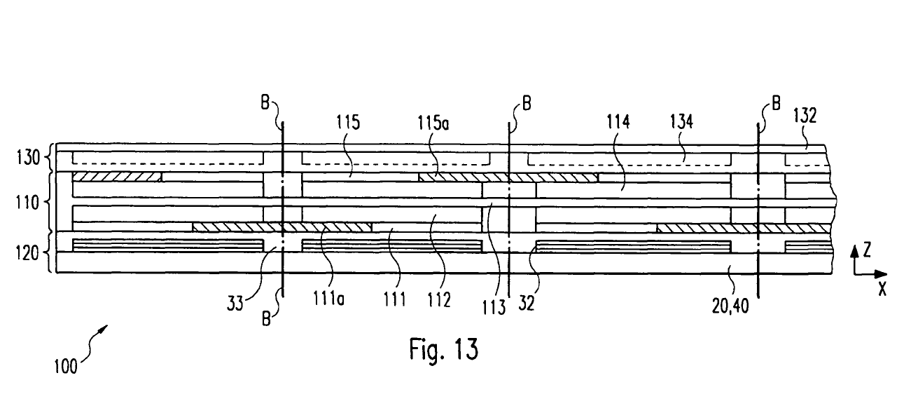

FIG. 13 a sectional view along a plane indicated by the dotted “XIII” line from FIG. 10 of a surface of a sensor arrangement in the cell of FIG. 10 in the viewing direction of the associated arrow; and

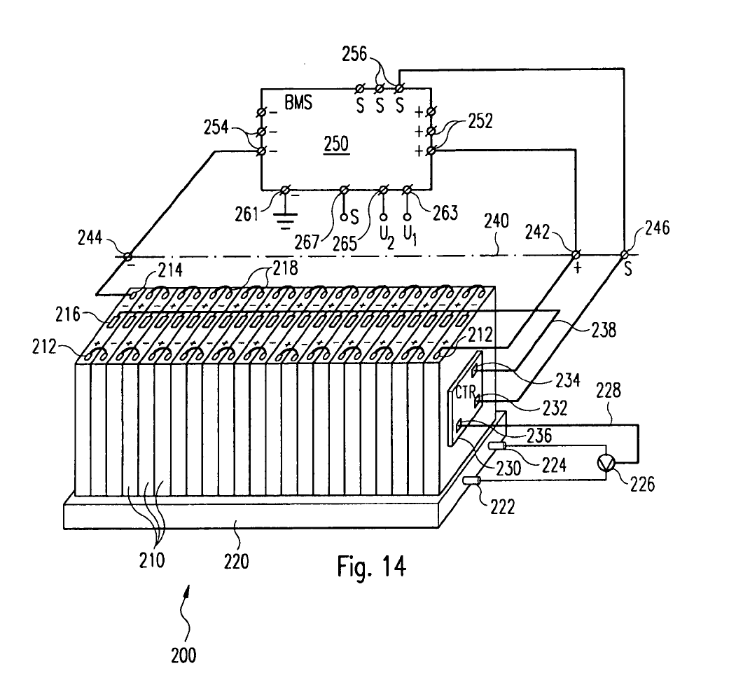

FIG. 14 a schematic representation of a battery block comprising a plurality of flat cells and a battery management system in accordance with a further embodiment of the invention.

It is pointed out that the representations in the figures are schematic and are limited in rendition to the features useful in appreciating the invention. It is also pointed out that the dimensions and proportions portrayed in the figures are essentially due to ensuring the clarity of the representations and are in no way to be viewed as limiting unless the description indicates otherwise.

The following will describe one embodiment of the invention with reference to the depiction provided in FIGS. 1 and 2. FIG. 1 is thereby a spatial view of an RMS arrangement 10 and FIG. 2 is an enlarged cross-sectional depiction of detail II of the RMS arrangement 10 from FIG. 1. In the present application, an RMS arrangement is to be understood as a configuration having a reactive multilayer (RMS).

According to the depiction of FIG. 1, the RMS arrangement 10 comprises a carrier film 20 and a reactive multilayer (RMS) 30. Two spatial coordinate directions x, y are defined from one corner of the carrier film 20 which is selected as zero point without restricting the generality.

In the present embodiment, the carrier film 20 is made—without restricting the generality—from a polyimide material.

The reactive multilayer 30 is arranged on the carrier film 20 in strips (RMS strips) 32 which extend along the y-coordinate direction. Channels 33 are formed between the strips 32 which likewise extend in the y-coordinate direction. Each strip 32 is clearly identifiable, for example by the x-coordinate of its centerline.

As more clearly depicted in FIG. 2, the reactive multilayer 30 comprises a plurality of first individual layers 34 and second individual layers 35. In this embodiment, the individual layers 34, 35 are alternatingly produced—without restricting the generality—from nickel and aluminum. It is to be noted that the number of six individual layers selected in the figure, in particular the three first individual layers 34 of nickel and the three second individual layers 35 of aluminum, is due solely to purposes of illustrative representation. In the actual layered structure, the reactive multilayer 30 comprises several hundred up to some several thousand individual layers on an order of magnitude of 10-100 nm thick each.

The reactive multilayer 30 thus consists of two different materials which release energy when chemically combined (exothermic reaction). There is thus a defined amount of chemical energy stored in the reactive multilayer 30, or in each strip 32 respectively, which can be used as a local heat source. After ignition by an external energy source such as e.g. an electrical spark or laser pulse, an atomic interdiffusion of the multilayer materials is triggered along with the release of energy. A progressive reaction front is formed from which a large amount of thermal energy is released in a spatially limited area within a very short amount of time.

Without restricting the generality, the width of an RMS strip 32 is in the range of a few centimeters. Depending upon the application, the RMS strips 32 can also be wider, for instance several decimeters, or narrower, for instance several millimeters, or even finer, for instance in the submillimeter range. The width of the channels 33 corresponds to the distance between two strips 32 of the reactive multilayer 30. This distance is calculated such that when one strip 32 is ignited, the adjacent strip 32 will not be ignited. Hence, the exothermic reaction of the reactive multilayer remains restricted to the ignited strip 32.

The strips 32 are configured with regular widths and separation distances. They thus form a one-dimensional grid, whereby each strip 32 is clearly identifiable, for example from the spatial coordinate x of its centroid.

The following will describe a further embodiment of the invention with reference to the depictions provided in FIGS. 3 and 4. FIG. 3 is thereby a spatial view of an RMS arrangement 10 and FIG. 4 is an enlarged cross-sectional depiction of detail IV of the RMS arrangement from FIG. 3.

In accordance with the depiction of FIG. 3, the RMS arrangement 10 comprises a carrier film 20, a reactive multilayer 30 and a functional layer 40. Two spatial coordinate directions x, y are defined from one corner of the carrier film 20 which is selected as zero point without restricting the generality.

In contrast to the previous embodiment, the reactive multilayer 30 is not arranged in strips but rather in rectangular, in particular substantially square spots (RMS spots) and/or points (RMS points) 32′ on the carrier film 20 and channels 33 are disposed between the spots 32′ which not only extend in the y-coordinate direction but additionally in the x-coordinate direction so as to form a reticular or grid-like pattern. Without restricting the generality, the length to the edge of an RMS spot 32′ is in the range of a few centimeters. Depending upon the application, the RMS spots 32′ can also be wider, for instance several decimeters, or narrower, for instance several millimeters, or even finer, for instance in the submillimeter range.

The spots 32′ are configured with regular edge lengths and separation distances. They thus form a two-dimensional grid, whereby each spot 32′ is clearly identifiable from the spatial coordinates x, y of its centroid. In all other respects, the specifications provided with respect to the previous embodiment can apply analogously to the basic structure of the carrier film 20 and the reactive multilayer 30 with individual layers 34, 35.

As more clearly depicted in FIG. 4, the functional layer 40 comprises a plurality of circuit elements 42 connected to a respective contact 44 by a respective conductor arrangement 43. Each spot 32′ of the reactive multilayer 30 is associated with one circuit element 42. The circuit elements 42 are designed and disposed so as to emit an ignition pulse suited to igniting its associated spot 32′ of the reactive multilayer 30. The functional layer 40 is thus formed in a circuit layer or a semiconductor layer which has an integrated network of circuits (transistor network, etc.) corresponding to the arrangement of RMS spots 32′.

A filler material 50 is disposed between the spots 32′ and covers same. The filler material 50 serves in electrically separating the spots 32′, filling the open space between them, structurally stabilizing the RMS arrangement 10 and protecting the reactive multilayer 30 from external mechanical, electrical and/or thermal influences.

FIG. 5 depicts a further embodiment as a special configuration of the previous embodiment in a cross-sectional view corresponding to FIG. 4. In this embodiment, each circuit element 42 comprises a combinatorial circuit 42a, a switching transistor 42b and an operational amplifier 42c. The combinatorial circuit 42a comprises an appropriate auxiliary or associated circuit and can be connected for example to a supply voltage, a control voltage (signal voltage) and a ground potential by means of contacts 44a, 44b, 44c. The output of the operational amplifier 42c leads to a base 46 in the proximity of one end of a spot 32′ of the reactive multilayer 30 via a branch line. A shielding layer 48 is configured on the surface of the functional layer 40 facing the reactive multilayer 30. The end of each spot 32′ of the reactive multilayer 30 on the far side of the functional layer 40 is connected to a ground layer 60 which is grounded by means of contact 64.

It is to be understood that the priority of depicting a switching transistor 42b and an operational amplifier 42c is illustrating the function. Same consists of switching and thus amplifying an applied voltage such that a voltage pulse applied to the base 46 is suitable to ignite the adjacent spot 32′ of the reactive multilayer 30. As the opposite terminal for voltage applied to the base 46 and for conducting a transmitted charge pulse as needed, the end of each spot 32′ of the reactive multilayer 30 on the far side of the functional layer 40 is connected to the ground layer 60.

FIG. 6 will be used to clarify the functioning of the above-described arrangement. FIG. 6 is an enlarged depiction of detail VI from FIG. 5 in a state of actuation of a circuit element 42 of the functional layer 40 in which of circuit elements 42, only the output end of the operational amplifier 42c is depicted.

FIG. 6 shows the state in which an ignition voltage U₁ supplied by the circuit element 42 is applied between the base 46 and the ground layer 60. An arc A through which a current I flows forms. The current pulse I causes the first individual layers 34 to react with the respective adjacent second individual layers 35, starting from the location of arc A. A reaction front or a reaction zone 36 respectively forms which is limited by boundary surfaces 36a, 36b and advances from the location of the arc at a speed v until reaching the opposite end of the spot 32′ (not shown in the figure). The individual layers 34, 35 of spot 32′ beyond the first boundary surface 36a of the reaction front 36 remain unaffected while the individual layers 34, 35 beyond the second boundary surface 36b of the reaction front 36 react fully and a mixed material 38 formed. Heat is produced in the reaction zone 36 which flows off as heat flow Q.

The shielding layer 48 shields the functional layer 40 from the heat generated in the reactive multilayer 30 so as to maintain the functioning of the circuit arrangement in functional layer 40; it is designed in particular also as a reflective layer having high reflectivity for thermal radiation.

The base 46 to RMS layer 30 is tapered to concentrate the charge.

FIG. 7 depicts an RMS arrangement 10 according to a further embodiment of the invention in a representation corresponding to FIG. 2. In this embodiment, the functional layer 40 is arranged between the carrier film 20 and the reactive multilayer 30. Combinatorial circuits 42 of the functional layer 40 are connected to a conductive layer 49 configured on the side of the carrier film 20. Each combinatorial circuit 42 comprises a laser diode 42d (semiconductor laser) able to be actuated by the combinatorial circuit 42. (A switching transistor provided for the purpose in not shown in any greater detail in the figure.)

Each laser diode 42d is aligned such that it irradiates a face of an RMS spot 32′ of the reactive multilayer 30 through a gap in the shielding layer 48. The radiation intensity, radiation energy and wavelength of the laser diode 42d are designed so as to be able to ignite the RMS spot 32′ with one pulse.

In a not further depicted modification, RMS strips or RMS spots (generally designated the RMS area) are combined with circuit elements or parts of the circuit elements in a single layer. For example, a base or other element to ignite the RMS area can be disposed in the vicinity of the RMS area; i.e. enclosed by the RMS area. In another not further depicted modification, circuit elements and conductor structures are integrated with the RMS area in one layer. For example, grid structures of RMS areas can be enclosed by circuit elements and conductor structures, segmentally if need be. Grid structures of RMS areas with circuit elements can be configured and produced analogously to TFT monitors (thin-film transistor liquid crystal displays) and be correspondingly actuatable.

In another not further depicted modification, the functional layer 40 serves as the substrate for the reactive multilayer 30 so that an additional carrier film 20 can be dispensed with.

A method for manufacturing an RMS arrangement will be described as a further embodiment of the invention with reference to the method steps depicted in FIGS. 8A to 8B.

A carrier film 20 is provided in the method step depicted in FIG. 8A.

In a plurality of method steps depicted from right to left in FIG. 8B, alternating deposits are made on the surface 22 of the carrier film 20 through a mask 70 by means of a physical chemical vapor deposition process; i.e. a first reactive material 72, e.g. nickel, is first deposited to form a first individual layer 34, then a second reactive material 73, e.g. aluminum, to form a second individual layer 35, then a first reactive material 72 again to form a further first individual layer 34, etc., until the desired number of individual layers 34, 35 is reached. The mask 70 thereby shields those areas on the surface 22 of the carrier film 20 which correspond to the channels 33 of the reactive multilayer 30.

In a method step depicted in FIG. 8C, a filler material 74 is deposited on the exposed surfaces of the carrier film 20 and the reactive multilayer 30. The deposited filler material 74 forms the filler material 50 in the RMS arrangement.

In a method step depicted in FIG. 8D, excess filler material 50 is removed so as to achieve a smooth surface 52.

Further method steps for forming functional layers such as in particular by forming semiconductor layers and conductive layers etc. are widely known in the art and will not be described to any greater degree here.

Thus, an RMS arrangement 10 is finished.

The physical chemical vapor deposition process can utilize for example, but not restrictively, magnetron/ion beam sputter deposition.

The following will refer to the method steps depicted in FIGS. 9A to 9B in describing a method for manufacturing an RMS arrangement as a further embodiment of the invention.

A carrier film 20 is provided in the method step depicted in FIG. 9A.

In a plurality of method steps depicted together in FIG. 9B, a first reactive material 72 to form a first individual layer 34 and a second reactive material 73 to form a second individual layer 35 are alternatingly deposited on the surface 22 of the carrier film 20 by a physical chemical vapor deposition process until the desired number of individual layers 34, 35 is reached to form a reactive multilayer 30.

In a method step depicted in FIG. 9C, a mask 78 is positioned on the surface of the reactive multilayer 30. The mask 78 can be formed in not further depicted method steps or merely laid atop.

In a method step depicted in FIG. 9D, the surface of the reactive multilayer 30 is etched through the mask 78 by means of an etchant 78 so as to form channels 33.

In a method step depicted in FIG. 9E, the mask 78 is removed so as to expose the surface of the reactive multilayer 30 and the surface of the carrier film 20 forming the base of the channels 33.

In further method steps not depicted to any greater extent, a filler material is deposited and smoothed in correspondence to the depictions provided in FIGS. 8C and 8D of the previous embodiment.

Further method steps for forming functional layers such as in particular by forming semiconductor layers and conductive layers etc. are widely known in the art and will not be described to any greater degree here.

Thus, an RMS arrangement 10 is finished.

In modifications of the above-described manufacturing method not depicted in any greater detail, a functional layer can first be formed on the carrier film 20 in order to form the reactive multilayer 30 thereon or the functional layer 40 itself can serve as the substrate for the reactive multilayer 30.

In one method according to an alternative, not further graphically depicted embodiment, a reactive multilayer is initially deposited on a carrier film as a continuous surface and channels are thereafter formed mechanically, photo-lithographically/chemically or by means of another process in order to separate areas of the reactive multilayer from one another. In one modification, the reactive multilayer is of self-supporting design, thereafter deposited on a carrier film or a functional layer and connected to same, e.g. by adhesive or the like; a reactive multilayer procured from another source can also be used.

In one method according to a further alternative, not further graphically depicted embodiment, the reactive multilayer is deposited, for instance by robotic feeding, as individual areas which can correspond for example, but not restrictively, to the strips 32 in FIG. 1 or the spots 32′ in FIG. 3. This can be accomplished by applying (depositing) the individual layers in rastered layers or by depositing and joining individual pre-cut pieces of a prefabricated reactive multilayer or by repeated process printing as required or the like.

The above-described method steps are at least in part borrowed from or comparable to semiconductor technology. Both large-area structures with edge lengths of several centimeters or decimeters as well as also small-format structures in the millimeter or submillimeter range as well as the smallest structures as are common in integrated circuit systems are possible. This holds true for both the RMS areas as well as the associated circuit elements.

Reference will be made in the following to the depiction provided in FIG. 10 in describing an electrode assembly as a further embodiment of the present invention. FIG. 10 is a spatial representation of an electrode assembly 100. A spatial coordinate x extends substantially to the right, a spatial coordinate y perpendicularly upward in the drawing plane. A thickness direction z of the electrode assembly 100 essentially extends into the drawing plane. Without restricting the generality, a zero point (0, 0, 0) is defined in the lower left corner facing the viewer. The figure only depicts one part of the electrode assembly 100, which continues further in the direction of spatial coordinate x.

The electrode assembly 100 comprises a layer arrangement 102 as well as a plurality of negative contacts 104 and a plurality of positive contacts 106. The contacts 104, 106 are only depicted schematically.

The layer arrangement 102 comprises a galvanic array 110 which is sandwiched between a reactive arrangement 120 and a sensor arrangement 130.

The galvanic array 110 is a galvanic secondary element which converts chemical energy into electrical energy in a discharge reaction and can store it as same and absorbs electrical energy in a charge reaction, converts it to chemical energy and can store it as same. It comprises a plurality of layers: A first collector layer 111 exhibits in succession a first electrode layer 112, a separator layer 113, a second electrode layer 114, a second collector layer 115 and an insulating layer 116. As defined by the conventions relating to a galvanic element, the first electrode layer 112 is an anode; i.e. negatively charged, while the second electrode layer 115 is a cathode; i.e. positively charged.

The design of such galvanic arrays is known per se. Without limiting the generality, the first electrode layer 112 (anode) comprises a lithium-intercalatable material such as for instance graphite, nanocrystalline, amorphous silicon, lithium titanate, tin dioxide or the like. Without limiting the generality, the second electrode layer 115 (cathode) comprises a lithium compound, e.g. one or more lithium metal oxides such as for example definable by an empirical formula LiCoₙNiₘMgₗXₖAl₁₋₍ₙ₊ₘ₊ₗ₊ₖ₎O₂ (wherein X is any given metal, wherein 0≦ (n, m, l, k)≦1, and wherein (n+m+l+k)≦1), a lithium metallic phosphate such as for example lithium iron phosphate, or a lithium-intercalatable material. The separator layer 113 spatially and electrically separates the anode 112 from the cathode 114; i.e. in particular does not conduct electrons although does conduct lithium ions.

Without limiting the generality, the separator layer 113 comprises an organic, in particular polymeric, at least partially material-permeable base material such as for instance PET, preferably in the form of a non-woven fabric, and an inorganic, in particular ceramic material such as for instance zirconium oxide, preferably as particles, the largest diameter of which preferably does not exceed 100 nm. EP 1 017 476 B1 describes such a separator and a method for its manufacture. A separator having the above-specified properties is currently available from Evonik AG, Germany, under the trade name of “Separion.” In preferential modifications, the inorganic material can also be another suitable ceramic compound, particularly from the group of oxides, phosphates, sulfates, titanates, silicates, aluminosilicates having at least one of the elements Zr, Al, Li. The separator material can generally be any lithium ion-conducting electrolyte and can comprise one or more microporous plastics or glass fiber or polyethylene non-wovens.

The collector layers 111, 115 comprise for example a conductor film, particularly a metal film, or a plastic film coated with conductive material, particularly metal. Without limiting the generality, the collector layers 111, 115 comprise copper, aluminum, zinc, gold, silver or an alloy thereof, a conductive ceramic material, carbon nanotubes or an otherwise conductive nanomaterial.

The first collector layer 111 comprises a plurality of tab-like, rectangular conductor lugs (first or negative conductor lugs) 111a which protrude from the top of the galvanic array 110. The second collector layer 115 likewise comprises a plurality of tab-like, rectangular conductor lugs (second or positive conductor lugs) 115a which protrude from the top of the galvanic array 110. The negative and positive conductor lugs 111a, 115a alternate in the direction of spatial coordinate x. The negative conductor lugs 111a are respectively connected to a negative contact 104 and the positive conductor lugs 115a are respectively connected to a positive contact 106. The negative contacts 104 are interconnected and the positive contacts 106 are likewise interconnected as symbolized in the figure by the dashed lines.

Each of the layers 111 to 116 can be its own separate film. Alternatively, only some of the layers can be designed as independent films while the other layers can be formed on said films. Without limiting the generality, the collector layers 111, 115 and the separator layer 113 are formed as independent films in the present embodiment, therefore can also be called collector films 111, 115 and separator film 113, the first electrode layer (anode layer) 112 is formed on the first collector film 111 and the second electrode layer (cathode layer) 114 is formed on the second collector film 112.

One positive conductor lug 115a and one negative conductor lug 111a in each case define a segment of the galvanic array 110 which extends over a common width of the two conductor lugs 111a, 115a in the direction of spatial coordinate x. In one modification, the segmenting can be materially realized by respective gaps in the collector layers 111, 115, and also as need be in the electrode layers 112, 114.

The reactive arrangement 120 corresponds to the RMS arrangement 10 of the first embodiment. The figure depicts a carrier film 20, a number of strips 32 of a reactive multilayer oriented in the direction of spatial coordinate y with channels 33 and a filler material 50 positioned therebetween. A functional layer and respective connection contacts are not depicted to any greater degree in the figure; without limiting the generality, the functional layer is formed in or on the carrier film 20.

The sensor arrangement 130 is depicted more precisely in FIG. 11. In accordance with the FIG. 11 representation, which is a plan view of sensor arrangement 130, a plurality of surface sensors 134 are arranged on a carrier film 132. The surface sensors 134 cover at least approximately the area of a segment of the galvanic array 110 (FIG. 10). The surface sensors 134 are temperature sensors which sense the temperature in their vicinity and can output the sensing results as the corresponding signals via contacts 134a, 134b. A conductive layer configured for this purpose is not depicted in any greater detail in the figure. Without limiting the generality, said conductive layer is formed in or on the carrier film 132.

The outermost right surface sensor 134 is shown partly exposed in FIG. 11. A plurality of photodiodes 134c are arranged as a matrix or an array. The photo-diodes 134c are particularly sensitive to long-wavelength light, particularly in the infrared range. The surface sensor thus exhibits the structure of a CCD array (a charge-coupled device matrix). The surface sensor 134 can thus be referred to as an infrared CCD sensor. The structure and actuation of CCD sensors are well known in the art such as for instance in “Digital Camera Fundamentals,” ANDOR Technology, www.andor.com, or in the “Charge-coupled device” or “CCD-Sensor” entries in Wikipedia's internet encyclopedia (www.wikipedia.com).

The surface sensors 134 can contain a part of their actuation logic; parts of the actuation logic for the surface sensors 134 can also be contained in the conductive layer.

The surface sensors 134 enable detecting the temperature condition of the galvanic array 110 in segments. From the temperature condition of the galvanic array 110, in particular the spatial (in the direction of spatial coordinate x) and temporal temperature gradient, conclusions can be drawn as to the state of the galvanic array 110.

In one modification not depicted to any greater degree, a resistance sensor is provided as the temperature sensor in place of a CCD sensor. In a further modification not depicted to any greater degree, a point-sensing temperature sensor, arranged e.g. in the centroid of a segment, is provided in place of a surface sensor.

FIG. 12 shows a schematic plan view of the top of the electrode assembly 100 with lines, contacts and a controller 150. Segment borders of the electrode assembly 100 are symbolized with dashed segment boundary lines “B.”

In accordance with the FIG. 12 depiction, the contacts 134a, 134b of the surface sensors 134 are connected to a conductor arrangement 136 which terminates in a sensor contact 136a. The conductor arrangement 136 is part of or integratable into a bus system. In one modification, the contacts 134a, 134b of the surface sensors are not connected or interconnected via a bus system, rather the conductor arrangement 136 comprises a plurality of conductors each associated with one contact 134a, 134b.

The negative contacts 104 of the negative conductor lugs 111a are inter-connected by means of an anode connecting line 118 which terminates in an anode contact 118a. The positive contacts 106 of the positive conductor lugs 115a are likewise interconnected by means of a cathode connecting line 119 which terminates in a cathode contact 119a.

The contacts 44a, 44b, 44c of strips 32 of the reactive multilayer (reactive arrangement 120) are connected to a conductor arrangement 122 which terminates in an RMS contact 122a. The conductor arrangement 122 is part of or integratable into a bus system. In one modification, the contacts 44a, 44b, 44c of the surface sensors are not connected or interconnected via a bus system, rather the conductor arrangement 122 comprises a plurality of conductors each associated with one contact 44a, 44b, 44c.

The contacts 118a, 119a, 122a, 136a can be connected to contacts 150a of an electronic control unit (CTR) 150 by means of a cable harness 140. The control unit 150 is designed to evaluate the outputs of the surface sensors 134, derive a temperature profile for the electrode assembly 100 therefrom, compare the temperature profile for example to normal values, thresholds and alarm criteria, and obtain a status prognosis therefrom. The evaluation is performed segment by segment and can thereby also incorporate temporal characteristics. Should the status prognosis show that a predetermined ignition condition is met, the control unit 150 sends a signal to that RMS strip 32 of the reactive arrangement 120 associated with the defective segment, whereupon the associated circuit element 44 (FIG. 4, 5 or 7) generates an ignition pulse which ignites the RMS strip 32. It is understood that the predefined ignition condition is to be determined as a function of the specific application and control strategy. An ignition condition can for example, but not restrictively, be a segment of the galvanic array being defective in such a way that the entire galvanic array can be affected.

The defective segment is destroyed by the exothermic reaction of the RMS strip 32. The thermal energy produced by the RMS strip 32 reaction is dimensioned such that either the current flow into/out of the segment is interrupted or the conversion function from chemical into electrical or electrical into chemical energy is inactived or the energy storage capacity of the segment is quashed without a short circuit being produced between the segment's collector layers. In particular, but not restrictively, the thermal energy from the reaction of the RMS strip 32 is dimensioned such that in the respective segment
the ionic conductivity of the separator layer 113 is lost (while its electrical non-conductive properties are maintained), for instance by fusing or partial melting and the pores consequently clogged by a microporous material, or
the ionic intercalatability or the ion incorporating ability or the anode layer and/or cathode layer ionic bond respectively is lost, or
the collector layer closer to the RMS strip 32 vaporizes or reacts into a non-conductor (if need be with a reactant provided for the purpose in a layer adjacent to the collector layer), or
the entire structure of the galvanic array 110 vaporizes or fuses such that the damaged spot is quasi melted out of the layered structure.

It is understood that the layered structure of a reactive arrangement 120 in the electrode assembly 100 can correspond to any of the above-described given embodiments depicted in FIGS. 1 to 7 with their modifications. In particular, use of the invention is not limited to RMS strips of segment width. The reactive arrangement 120 can comprise a plurality of strips per segment, it can if necessary comprise a very finely rastered, two-dimensional matrix arrangement of RMS areas. Thus, small areas of the galvanic array 110 can also be selectively destroyed while surrounding areas remain functional.

FIG. 13 shows a modified electrode assembly 100 as a further embodiment of the present invention in a partially sectioned plan view. The electrode assembly 100 is a modification of the previous embodiment; the same reference numerals are used for the same and/or corresponding elements. The sectional plane is a horizontal plane; i.e. parallel to the x-z plane which runs through the conductor lugs 111a, 115a above the galvanic array 110. (The conductor lugs 111a, 115a, although formed from extensions of the collector films 111, 115, are not representationally treated here as part of the galvanic array 110 itself as they do not take part in the galvanic array 110 reaction.)

The construction of the electrode assembly 100 corresponds substantially to that of the previous embodiment; i.e. a galvanic array 110 is disposed between a reactive arrangement 120 and a sensor arrangement 130. The reactive arrangement 120 is an RMS arrangement corresponding to the FIGS. 1 and 2 depictions with a carrier layer 20, which here contains a functional layer 40, and a reactive multilayer (RMS) designed in the form of strips 32 on the carrier layer 20 separated from one another. The sensor arrangement 130 comprises a carrier layer 132 as well as a plurality of surface sensors 132 more or less opposite the RMS strips 32 of the reactive arrangement 130 and more or less covering the same surface area. The surface area covered by the RMS strips 32 and the surface sensors 132 mark the segments of the electrode assembly such that segment boundaries B are respectively defined between said surface areas.

The galvanic array 110 comprises in the indicated order a first collector layer 111 with first conductor lugs 111a, a first electrode layer 112, a separator layer 113, a second electrode layer 114 and a second collector layer 115 with second conductor lugs 115a. As in the preceding embodiment, the first electrode layer 112 can be described as an anode layer and the second electrode layer 114 can be described as a cathode layer; as far as the functioning and the material selection, that as noted above applies accordingly. A final insulating layer is not depicted in the present embodiment and can also be omitted. The surface sensors 132 of the sensor arrangement 130 can be coated with an insulating material.

The separator layer 113 is of continuous design in the direction of spatial coordinate x. The collector layers 111, 115 and the electrode layers 112, 114 are in contrast of discontinuous configuration such that either electrode layer 112, 114 in each case is interrupted in the area of a segment boundary B and the first collector layer 111 and the second collector layer 115 are alternatingly interrupted in the area of the segment boundary. The gaps in the interrupted areas can be filled with separator material or electrolyte material.

The material gaps in the area of the segment boundaries B facilitate a folding and/or coiling of the electrode assembly 100 of this embodiment. In the finished fold or the finished coil, all of the first conductor lugs 111a are disposed at one corner and all of the second conductor lugs 115a are lined up in the direction of thickness z. The connection of the conductor lugs 111a, 115a, symbolized in the previous embodiments by contacts 104, 106 and lines 118, 119, can be realized by simply pressing the aligned conductor lugs 111a, 115a together or by clamping, clipping, soldering, riveting, etc. them. Should lines run to the respective outer layers in the area of the segment boundaries B at which the electrode assembly is respectively bent by 180°, excessive stretching of the lines can be avoided by the appropriate design, for instance a slanted or serpentine form.

A method of manufacturing an electrode assembly 100 in accordance with the above description which is not depicted to any greater extent includes a manufacturing method as depicted in FIGS. 8A et seq. and 9A et seq. for an exothermic element which forms a reactive arrangement 120 of the electrode assembly 100 or a modification thereof. Further method steps for manufacturing other parts of the electrode assembly 100, particularly the galvanic array 110 or the sensor arrangement 130, are generally known and will not be expounded upon here. The galvanic array 110 can thereby serve as a carrier layer or carrier film for the reactive arrangement.

FIG. 14 shows a schematic depiction of a battery block 200 having a battery management system 250 as a further embodiment of the present invention.

The battery block 200 comprises a plurality of flat cells 210 each exhibiting on their upper side a positive cell terminal contact 212, a negative cell terminal contact 214 and a cell signal contact 216. The flat cells 210 are arranged within the battery block 200 with alternating pole positions (+, −) and connected in series by means of intercell connectors 218 which respectively connect a positive cell terminal contact 212 of one flat cell 210 to a negative cell terminal contact 214 of an adjacent flat cell 210.

Although not shown in any greater detail in the figure, the flat cells 210 comprise an active part and a cell enclosure. The respective active part of the flat cells 210 comprises an electrode assembly configured as described above in conjunction with FIG. 10 et seq. and in particular a galvanic array of coiled, folded or stacked film construction, a rastered reactive arrangement (exothermic component) and a sensor arrangement (infrared CCD sensor). The positive conductor lugs of the electrode assembly are connected to the positive cell terminal contact 212 of the flat cell 210 and the negative conductor lugs of the electrode assembly are connected to the negative cell terminal contact 214 of the flat cell 210. A conductor arrangement for actuating circuit elements of the reactive arrangement and a conductor arrangement for actuating the sensor arrangement are further connected to a cell logic not depicted to any greater extent which comprises devices for identifying the flat cell 210, for buffering and transmitting signal data, for generating an ignition command signal and for transmitting the ignition command signal to a circuit element of the reactive arrangement. The cell logic, which comprises an integrated circuit, is connected to cell signal contact 216 and to the cell terminal contacts 212, 214.

The flat cells 210 are held by a block frame of which only a lower part 220 is shown in the figure. The block frame lower part 220 also comprises a coolant distributor for the temperature control of the flat cells 210. A coolant inlet flow connection 222 and a coolant return flow connection 224 of the coolant distributor are connected to a coolant pump 226.

A block controller (CTR) 230 is disposed at the outermost right flat cell 210 in the figure. The block controller 230 comprises devices for identifying the battery block 200, for buffering and transmitting signal data, for the charge balance (balancing) between the flat cells 210, for actuating the cooling circuit and for generating a supply voltage for the cell logics. The cell logic comprises an integrated circuit, an internal signal connection 232, an external signal connection 234 and a pump signal connection 236. The internal signal connection 232 is connected to the cell signal contacts 216 of the flat cells 210 by means of a block bus 238. The pump signal connection 236 is connected to the coolant pump 226 via a pump signal line 228.

A dash-dotted line 240 in the figure symbolizes a system boundary of the battery block 200. A positive block terminal contact 242, a negative block terminal contact 244 and a block signal contact 246 are disposed at the system boundary 240. The positive block terminal contact 242 is connected to the positive cell terminal contact 212 of the outermost right flat cell 210, the negative block terminal contact 244 is connected to the negative cell terminal contact 214 of the outermost left flat cell 210, and the block signal contact 246 is connected to the signal connection 234 of the block controller 230. All of the block connections 232, 234, 236 can for example, but not restrictively, be embodied in a multi-pole block system connector socket.

The battery block 200 is connected to a battery management system (BMS) 250. The battery management system 250 comprises a plurality of positive inputs 252, a plurality of negative inputs 254 and a plurality of signal inputs/outputs 256; hence, one respective positive input 252, negative input 254 and signal input/output 256 each can be consolidated into one multi-pole system connection. The battery management system 250 further comprises a negative total output 261, which is grounded, a first positive output 263, which provides a first voltage potential U₁, a second positive output 265, which provides a second voltage potential U₂, and a signal output 267.

The positive block terminal contact 242 of the battery block 200 is connected to a positive input 252 of the battery management system 250, the negative block terminal contact 244 of the battery block 200 is connected to a negative input 254 of the battery management system 250, and the block signal contact 246 of the battery block 200 is connected to a signal input/output 256 of the battery management system 250.

The battery management system 250 is designed as an electronic processing and/or control unit and comprises devices for converting voltages, for buffering, storing and transmitting signal data, for evaluating signal data, for generating display signals and for generating command signals.

A method for monitoring the battery block 210 is distributed among the battery management system 250, the block controller 230 and the individual cell logic levels (not depicted to any greater extent). Only the processing of the sensor data from the sensor arrangements in the flat cells 210 and actuating the reactive arrangements in the flat cells 210 is detailed in the context of the present application; battery management methods generally including ageing management, cell balancing, temperature control, etc., which can likewise be distributed among the cited levels, do not constitute subject matter of the present application and not clarified to any further extent here.

The output signals of the CCD sensors of the flat cells 210 are buffered in the cell logics and transmitted to the block controller 230 or retrieved from same respectively via the block bus 238. The output signals of the CCD sensors are provided as a data set with a cell identification of the individual flat cell 210, a time stamp and a sensor identification for each individual CCD sensor of the sensor arrangement, followed by spatial coordinates and a voltage value for each of the photodiodes in the sensor. The voltage values can be normalized prior to the transmission if necessary and/or averaged on an approximate grid. The voltage values can also be integrated or totaled over a predefined period of time and then normalized. A single mean value of the output signals can also be generated, buffered and transmitted for each sensor of the sensor arrangement. Should the sensor arrangement of a flat cell only comprise one sensor, sensor identification can be omitted. In place of spatial coordinates, a counter which can be converted into spatial coordinates at a later point in time can also be used for each photodiode.

The output signals of the CCD sensors are buffered in the block controller 230 and transmitted to the battery management system 250 or retrieved from same. A data block transmitted to the battery management system 250 comprises the buffered output signals of the CCD sensors of all of the flat cells 210 of the battery block 200 with a predefined time stamp and a block identification of the battery block 200. The sensor signals can also be averaged and/or temporally integrated and/or totaled and/or normalized prior to transmission at this level.

The output signals of the CCD sensors are evaluated in the battery management system 250. The output signals are stored there for a predefined period, if necessary for the life of each flat cell 210, correlated with charge or charging cycles, compared to target values and/or target ranges, etc. Should the output signals of the CCD sensors indicate that a certain area of an electrode assembly of a flat cell 210 is defective, the battery management 250 assesses whether the failure is permanent and whether the failure is critical on the basis of predetermined scenarios. The presence of a failure can for example, but not restrictively, be assessed on the basis of the temporal temperature gradient and the temperature distribution in the two-dimensional sensor arrangement matrix; further criteria such as for instance charge state, cell voltage and the like can additionally be considered. The failure can in particular, but not restrictively, be assessed as critical when the output signals of the CCD sensors indicate that it extends to adjacent areas of the electrode assembly. The criticality of the failure can be classified into stages: a high criticality can for example, but not restrictively, be characterized by the failure spreading quickly or that the type of failure portends an impending “runaway” or a short-circuiting of the cell. The permanence of a failure can for example, but not restrictively, be assessed by the targeted actuation of the flat cell 210, by running recovery cycles at reduced charge or the like; if applicable, the battery management 250 can determine that the area has recovered again.

Should the battery management system 250 determine that a failure is critical and permanent, or that a failure while not permanent is highly critical, the battery management system 250 sends a command signal to the block controller 230 to destroy one or more areas of one or more segments of the electrode assembly of the respective flat cell 210. The block controller 230 decides which areas (strips or pixels) of which segment of the associated reactive arrangement are to be ignited on the basis of the command signal received from the battery management system 250 and sends a command sequence containing the cell identification of the respective flat cell 210, the segment identification(s) of the respective segment(s) and the spatial coordinates (x, y) of the areas of the reactive arrangement to ignite via the block bus 238. The areas of the reactive arrangement to be ignited can also include, apart from the defect itself, a certain safety margin surrounding the defect. The cell logic of the respective flat cell 210 recognizes its being affected on the basis of the cell identification and generates switching signals for the circuit elements of the respective areas of the reactive arrangement with the corresponding spatial coordinates x, y. Each circuit element actuated by a switching signal generates an ignition pulse to ignite the associated area of the reactive arrangement.

The ignited areas of the reactive arrangement react exothermally and destroy the associated areas of the electrode assembly without affecting adjacent areas. The non-affected areas of the electrode assembly remain intact and can continue to perform their function. The affected flat cell 210 remains, depending on the extent of the failure and depending on the roughness/fineness to the grid of the reactive multilayer in the reactive arrangement, in operation with more or less reduced capacity. The operating life of the flat cell 210 can be considerably increased.

Although the present invention has been described above referencing concrete embodiments and a number of modifications to their essential features, it is understood that the invention is not limited to said embodiments but rather can be modified and expanded to the extent and scope defined by the claims, for example, but not restrictively, as indicated below.

The circuit and/or sensor elements can be dispensed with when the reactive multilayer is designed such that the RMS areas react automatically upon a predefined ignition condition. An ignition condition can for example, but not restrictively, be the presence of a predetermined temperature or a predetermined collector film potential.

The carrier film 20 is manufactured from a polyimide material in the embodiments. In modifications of the invention, other suitable materials can also be used as the carrier film. Nor is the invention limited to the use of a dedicated carrier film. Instead, a rastered reactive multilayer can be applied directly to a structural element as an exothermic component; the structural element then constitutes a substrate in the sense of the invention.

As an example of reactive multilayer material pairing, the embodiments make use of nickel and aluminum. Another known material pairing for an exothermic reactive multilayer, which is also suitable for use in the nano-range, comprises titanium and aluminum. The invention is not limited to these specific material pairings.

The invention is not limited in its applicability to lithium ion secondary cells. In fact, the invention can be applied to any other type of electrical energy cell, for example, but not restrictively, as was already noted in the introduction to the present description.

The invention is not limited to electrode assemblies with one-sided conductor lugs as depicted in the figures. Instead the invention can also make use for example, but not restrictively, of electrode assemblies in which the conductor lugs of a first type (e.g. positive conductor lugs) protrude from one side and conductor lugs of another type (e.g. negative conductor lugs) protrude from the opposite side. Such electrode assemblies can be designed such that the conductor lugs are configured as continuous edges since when the electrode assembly is coiled or folded, conductor lugs of only one type will then always be on one side. Notching is then unnecessary to form the tab-like conductor lugs.

The invention is not limited to coiled or folded electrode assemblies. Instead, the invention can also make use of for example, but not restrictively, stacked electrode assemblies. To this end, an electrode assembly as depicted in FIG. 10 et seq. can for example, but not restrictively, be cut at the segment boundaries so as to form cut sheets of equal width, wherein each sheet is then an electrode assembly in the sense of the invention, and said sheets can then be stacked, enclosed and made ready for use. In further modifications, a sheet can comprise a plurality of segments.

The battery management system 250 can provide only one voltage potential or more than two different voltage potentials. The distribution of the control levels between the battery management system 250, block controller(s) 230 and cell logics can deviate from the depicted hierarchy both toward stronger centralization as well as stronger decentralization.

As an alternative to a reactive multilayer, directly fusing the galvanic array with laser diodes disposed in the functional (circuit) layer is also conceivable.

Lastly, the invention is not limited to the feature combinations defined in the above embodiments and modifications and depicted in the figures. All the features of all the embodiments and modifications can be combined with one another, provided nothing to the contrary follows from the above description.

In summary, an exothermic component comprises a reactive multilayer arranged on a substrate as a grid. The exothermic component can be integrated into an electrode assembly of a galvanic cell having electrode layers, a separator layer and current collecting layers. A matrix-like sensor arrangement can be additionally provided in the electrode assembly. Based on the output signals of the sensor arrangement, defects can be detected in the electrode assembly. By igniting selected areas of the RMS grid which react exothermally, the defects can be selectively destroyed. The invention thus provides an effective hot spot safeguard for galvanic cells.

The RMS arrangement 10 and the reactive arrangement 120 are exothermic components in the sense of the invention. The carrier layer 20 is a substrate in the sense of the invention. A functional layer or the galvanic array 110 can also be a substrate in the sense of the invention. The strips 32 or spots 32′ respectively are areas in the sense of the invention and form a discontinuous grid-like arrangement (one-dimensional and/or two-dimensional grid) for a reactive multi-layer in the sense of the invention. Circuit elements 42 with their component parts 42a, . . . , 42d are circuit elements in the sense of the invention.

The electrode assembly 100 is an electrode construction in the sense of the invention. Collector layers 111, 115 are current collector layers in the sense of the invention. The sensor arrangement 130 is a second functional layer in the sense of the invention. Photodiodes 134c are sensor elements in the sense of the invention.

The flat cells 210 are electrical energy cells in the sense of the invention. The battery block 200 is a cell assembly in the sense of the invention. The battery management system 250 can be an actuation logic and an evaluation logic in the sense of the invention. The block controller 230 or a cell logic (not depicted to any greater degree) can likewise be an actuation logic and an evaluation logic in the sense of the invention. The block controller 230 is a control logic in the sense of the invention.

### List of Reference Numerals

10 RMS arrangement
20 carrier film
30 reactive multilayer
32 strips
32′ spots
33 channels
34 first individual layer
35 second individual layer
36 reaction zone/reaction front
36a, 36b boundary surfaces
38 mixed material
40 functional layer
42 circuit element
42a combinatorial circuit
42b switching transistor
42c operational amplifier
42d laser diode
43 line
44 contact
44a, 44b, 44c contacts
46 base
48 shielding layer
49 conductive layer
50 filler material
52 surface
60 ground layer
64 contact
70 mask
72 first reactive material
73 second reactive material
74 filler material
76 mask
78 etchant
100 electrode assembly
102 layer arrangement
104 negative contact
106 positive contact
110 galvanic array
111 first (negative) collector layer (current collecting layer)
111a first (negative) conductor lug
112 first (negative) electrode layer
113 separator layer
114 second (positive) electrode layer
115 second (positive) collector layer (current collecting layer)
115a second (positive) conductor lug
116 electrolyte layer
118 anode connecting line
118a anode contact
119 cathode connecting line
119a cathode contact
120 reactive arrangement
122 conductor arrangement
122a RMS contact
130 sensor arrangement
132 carrier film
134 surface sensor
134a, 134b contacts
134c (IR) photodiode
136 conductor arrangement
136 sensor contact
140 cable harness
150 electronic control unit
150a contacts
200 battery block
210 flat cell
212, 214 cell terminal contacts
216 cell signal contact
218 intercell connector
220 block frame
222 coolant inlet flow
224 coolant return flow
226 coolant pump
228 pump signal line
230 block controller
232 internal signal connection
234 external signal connection
236 pump signal connection
238 block bus
240 system boundary
242 positive block terminal contact
244 negative block terminal contact
246 signal contact
250 controller
252 positive input
254 negative input
256 signal input/output
A arc
B segment boundary
I current (pulse current)
L laser pulse
Q heat (flow)
U₁ ignition voltage
U₁, U₂ voltage potential
S signal
v propagation speed
x, y spatial coordinates
z thickness direction

It is expressly emphasized that the above list of reference numerals is an integral component of the present description.

1. An apparatus, comprising:
an arrangement of areas of a reactive multilayer on a substrate in a galvanic cell, the areas being delimited from one another; and
a functional layer of circuit elements arranged in a matrix to actuate at least one selected area of the reactive multilayer.

2. The apparatus according to claim 1, wherein the reactive multilayer has a rastered arrangement, and wherein the circuit elements arranged in a matrix are correlated to the reactive multilayer having the rastered arrangement.

3. An electrode for an electrical energy cell, comprising:
a successive arrangement of a first electrode layer, a separator layer and a second electrode layer, wherein the first electrode layer is connected to a first current collecting layer and wherein the second electrode layer is connected to a second current collecting layer, wherein the separator layer is disposed between the first electrode layer and the second electrode layer; and
an arrangement of areas of a reactive multilayer delimited from one another in accordance with claim 1.

4. The electrode according to claim 3, further comprising:
a second functional layer including sensor elements arranged in a matrix, wherein the sensor elements are configured to sense operating parameters of the electrode.

5. The electrode construction according to claim 4, wherein the second functional layer is integrated into a functional layer of an exothermic component.

6. The electrode construction according to claim 4, wherein the matrix of sensor elements correlates to the matrix of circuit elements or the reactive multilayer that has a rastered arrangement.

7. An electrical energy cell, comprising an electrode in accordance with claim 4.

8. The electrical energy cell according to claim 7, further comprising actuation logic to actuate the circuit elements.

9. The electrical energy cell according to claim 7, further comprising evaluation logic to evaluate sensor outputs.

10. A cell assembly comprising:
a plurality of electrical energy cells in accordance with claim 7; and
control logic connected to the evaluation logic and/or the actuation logic of the electrical energy cells of the cell assembly.

11. The cell assembly according to claim 10, wherein the evaluation logic and/or the actuation logic of the electrical energy cells are at least partially implemented in the control logic of the cell assembly.

12. A method for manufacturing an apparatus in accordance with claim 1, comprising:
furnishing a substrate; and
applying a reactive multilayer to the substrate in raster-defined areas.

13. The method for manufacturing an apparatus in accordance with claim 1, comprising:
furnishing a substrate; and
applying a reactive multilayer to the substrate; and
forming channels in the reactive multilayer in order to leave raster-defined areas in the reactive multilayer.

14. A method for actuating an electrical energy cell in accordance with claim 7, comprising:
assessing whether a defect is present in an electrode construction of the electrical energy cell;
determining a location of the defect, the location being expressed in two-dimensional coordinates; and
actuating at least one circuit element in order to route an ignition pulse to one area or a plurality of areas of the reactive multilayer corresponding to the two-dimensional coordinates of the defect.

15. The method for actuating an electrical energy cell according to claim 14, wherein assessing whether a defect is present includes:
processing output signals from the sensor elements.
